(19) United States
(12) Patent Application Publication
(10) Pub. No.: US 2002/0128033 A1
(43) Pub. Date: Sep. 12, 2002

(54) Communications control method and apparatus

(76) Inventor: Shelia Jean Burgess, Oviedo, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/056,246

(22) Filed: Jan. 24, 2002

Related U.S. Application Data
(63) Continuation-in-part of application No. 09/203,041, filed on Nov. 30, 1998, now Pat. No. 6,018,232.

(51) Int. Cl. H04Q 7/20

(52) U.S. Cl. 455/528; 455/405; 455/415; 455/567

(57) ABSTRACT

A communications controller is provided for empowering the user of a communications device, such as a telephone or other device, to assume control over incoming communications. This communications controller is based on artificial intelligence and behavior modeling techniques. Each communication is identified by unique identification information associated with an incoming communication. The user selects one of a plurality of different priority rating levels for a particular communication. The user also selects or infers block time intervals for each priority to indicate times during which incoming communication is not desired. Dynamic communications control is achieved by also determining the mood of the user or mode of the device. Undesirable communications will be “blocked”. For example, when that particular caller places a call to the user, the user's communication controller determines the caller's identification information and recalls the priority and corresponding blocking time interval for that particular caller. The user's mood or the mode of the communications device is determined. The call is accordingly passed to the communication device or blocked.

This application is a Continuation-In-Part of U.S. application Ser. No. 09/203,041 filed Apr. 16, 1999.

### BACKGROUND OF THE INVENTION

This invention relates in general to apparatus and methodology for controlling communications devices. More particularly, the invention relates to apparatus and methodology for permitting a user to control incoming communications supplied to a communications device such as a telephone in one example.

Today's consumer is being constantly bombarded and harassed by an ever-increasing volume of unwanted solicitation phone calls. Fundamentally, solicitors are using the passive telephone device to invade the general public's privacy at any time or within any domain that the solicitors choose. This level of harassment is especially annoying when it comes from a high-pressure and persistent telemarketing source. When posed with the question: “Would you purchase a telephone that would inhibit solicitors from calling you?” The answer is always an emphatic “YES!”

It is very desirable to provide telephone users with the capability of limiting their exposure to such unwanted telephone calls at the user's option. One conventional approach to this problem is the combined telephone/answering machine that permits the user to listen to the caller and then make a real time decision as to whether or not to pick up the telephone receiver and engage the caller. This is referred to as “call screening” in its most basic form. Of course, the user also has the option of listening to the caller's message at a later time and then making a decision as to whether or not to call back.

Another method of limiting the user's exposure to unwanted phone calls is described in U.S. Pat. No. 5,060,255 to Brown entitled “Telecommunications System With Timed-Do-Not-Disturb”. This patent discloses a telephone system that enables a subscriber to designate time periods during which no incoming calls are to be received over the subscriber line. Any calls dialed to the subscriber directory number at such times are diverted to a voice response unit that issues an appropriate announcement to inform the caller of the unavailability of the dialed number station. This timed call block feature is implemented in the telephone company's central office or switching facility.

Another call screening approach is disclosed in U.S. Pat. No. 5,467,388 issued to Redd, Jr. et al. entitled “Method And Apparatus For Selectively Blocking Incoming Telephone Calls”. In that patent, a system is disclosed for allowing a telephone subscriber to selectively block incoming calls for selected time periods or during programmed time intervals. In this approach, the call screening is again conducted at the telephone company's central office or switching facility.

One more conventional call screening technique is described in U.S. Pat. No. 4,277,649 issued to Sheinbein entitled “Method And Apparatus For Screening Telephone Calls”. In that patent, a telephone system is disclosed in which a called customer or user can screen calls incoming to his station based on the identity of the calling line. The calling line's identity is forwarded to the switching office containing the called customer's screening memory. The memory is interrogated to ascertain the call disposition based on information previously put in the memory by the called customer. In this approach, the screening process is once again dependent on screening conducted at the telephone company's central office or switching facility at which a centralized database is located.

### SUMMARY OF THE INVENTION

Accordingly, one object of the present invention is to provide a method and apparatus for limiting a communications device user's exposure to undesired communications by employing advanced control mechanisms implemented at or near the communications device.

Another object of the present invention is to provide a method and apparatus for limiting the user's exposure to undesired communications by employing advanced control mechanisms at the telephone service switcher and which are provided to the consumer as a service.

Another object of the invention is to provide communications device control methodology and apparatus that permit the consumer to proactively take control of how, when, and if the consumer responds to incoming communications.

Another object of the invention is to provide a methodology and apparatus for transforming the communications device (e.g., telephone, computer, and/or television) from a passive device to a controllable device that incorporates individual time management values and customized consumer priorities.

Another object of the invention is to provide a communications device control apparatus in which incoming communications are managed and controlled depending on the time-of-day, frequency, type, duration, mood of the receiving party, learned user behavior, events, and priority rating of the particular communications being received.

Another object of the invention is to have the user's schedule data influence the control of the communications.

Another object of the invention is to establish a user interface that learns the usage of the communications device based on the user's behavior patterns thus providing a user with an intelligent user interface that requires minimal to no programming.

Another object of the invention is to sense and respond to the mood of the user of the communications controller.

Another object of the invention is to provide an incoming communications rating ability that enables feedback to the Communications Controller. This permits the Communications Controller to become personalized to the individual user.

Another object of the invention is to capture short-term memory user behavior and treat it separately from the user behavior for long-term memory. This permits personalized, dynamic, proactive communications control responsive to the user's immediate needs while maintaining an overall long-term knowledge base.

Another object of this invention is to control incoming communications to effectively eliminate and/or control Spam, and receiving computer viruses via email, short message service (SMS), instant messaging, the Internet and other incoming communication.

Another object of this invention is to control incoming communications by personalizing the viewer experience by way of a customized content offering.

Another object of the invention is to provide the capability to selectively choose which device of a multiple of devices receives the incoming communication based on core Communications Control functions and based on the user's mood or the mode of operation of the devices being controlled. This capability uniquely employs intelligent agents.

A final object of the invention is to automatically process communication media per the user's needs so that features such as automatic encoding and decoding can be realized without any effort on the user's behalf.

In accordance with one embodiment of the present invention, a method is provided for processing an incoming communication from a calling party sent to a communications device of a receiving party. This embodiment is applicable for real-time incoming communications such as voice, instant messaging, and/or SMS. The disclosed method includes the step of storing a caller database including a plurality of records. Each record includes caller identification information corresponding to a particular caller. Each record also contains respective short-term and long-term ratings of the caller, constituting a continuous value of caller priority relating to different time scales. The method also includes the step of storing one or more time profiles corresponding to the willingness or reluctance to receive incoming communications at various times of day, day of the week, or other time criteria. The method also includes a means of sensing the user's mood to determine the user's willingness or reluctance to receive incoming communication at any particular time. This sensing may be explicit, allowing the user to directly convey the value of mood, or implicit, wherein the value of mood is inferred from, for example, voice stress analysis.

When an incoming communication is received, it includes some caller/sender identification information, and the time that the communication is received is determined to provide a call received time. The caller database is then searched to find a record having caller identification information matching the caller identification information of the incoming communication and the respective priority for that record is retrieved to produce a retrieved priority. The blocking time database is searched to determine blocking time information associated with the retrieved priority to produce retrieved blocking time information. The call received time of the incoming communication is compared with the retrieved blocking time information. The method further includes the step of blocking the incoming communication if the call received time occurs during a blockout time indicated by the retrieved blocking time information and otherwise permitting the incoming communication to be routed to the user of the communications device. The method further includes the step to check if the call being blocked is an emergency call that will be routed according to the consumer pre-selected options.

In accordance with another embodiment of the present invention, a method is provided for processing an incoming communication from an email source sent to an email communications device or client of a receiving party. This embodiment is applicable for processing incoming email, email attachments, and text type messaging in both real-time and non-real-time environments. The disclosed method includes the step of storing a user action history database including a plurality of records. Each record includes message identification, body coding, header coding, and a classification label. The method also includes the step for receiving an email message and screening it based on user action history and known messages to automatically accept and reject. Upon receiving an email that is questionable as to whether it should be received, the verifier notifies the email source to have them verify the email message. The email messages that are accepted get ranked based the user action history. Once ranked, they are priority listed along with a plurality of email messages priorities listed. These emails are then dispatched in one of a plurality of message folders awaiting the review of the user.

In accordance with the final embodiment of the present invention, a method is provided for processing incoming communications content thus controlling the viewing and listening of TV stations/channels based on the user's prior behavior, preferences, and mood. This embodiment is applicable for processing incoming content provided from a television, such as broadcast programs, digital music, or movies-on-demand in real-time and non-real-time environments. The disclosed method includes the step of storing a user action history database including a plurality of records. Each record includes content identification, descriptor coding, context coding, and a classification label. The method also includes the step for screening content based on the user action history. The content then gets ranked. The ranked content gets sent to a schedule priority list that consists of a plurality of content records. These content results are offered to the user via the director process, which has a stored schedule of content records among a plurality of records. The director then sends the required outgoing control signals to other components of the TV set-top box for the user's potential selection.

The issue of implementation of the Communications Controller in a distributed architecture is also disclosed using Intelligent Agents. These agents will work in concert with one another to accomplish the core logic disclosed in the embodiments.

### BRIEF DESCRIPTION OF THE DRAWINGS

The features of the invention believed to be novel are specifically set forth in the appended claims. However, the invention itself, both as to its structure and method of operation, may best be understood by referring to the following description and accompanying drawings.

FIG. 1 is a simplified system level diagram of a communication system with which the present invention may be used for a telephony type application.

FIG. 2 is a functional block diagram showing the overall relationship of the disclosed Communications Controller relative to other telecommunication device functions.

FIGS. 3a, 3b, and 3c are the flow diagrams of the Communications Controller system operation.

FIG. 4 is a user's mood selection scheme.

FIG. 5 depicts a telephone keypad that incorporates a call rating capability.

FIG. 6 is the intelligent decision-processing system.

FIG. 7 depicts the structure of a Caller ID database as it relates to the primary fields needed to support the processing logic of the Communications Controller.

FIG. 8 depicts the structure of a Time Block database as it relates to the primary fields needed to support the processing logic of the Communications Controller.

FIG. 9 depicts the look-up-table structure, which provides operational settings that are consequential functions related to the incoming call time and caller priority conditions.

FIG. 10 is a flow diagram depicting the unique Fuzzy Logic controller system operations.

FIG. 11 is a graph depicting a representation of the User Time Profile Fuzzy Set membership.

FIG. 12 is a graph depicting a representation of the Caller Priority Fuzzy Set membership.

FIG. 13 is a graph depicting a representation of the User Mood Fuzzy Set membership.

FIG. is a graph depicting a representation of the consequential Communications Controller Operations Fuzzy Set membership. This representation uses singletons to map directly to crisp solutions.

FIG. 15 is a block diagram of the hardware needed to support the Communications Controller. The implementation of the hardware can either be as a standalone unit that interfaces to Instantaneous Response Device, Messaging Response Device, and Caller Identification Device functions or an integrated element/feature set.

FIG. 16 is a simplified system level diagram of a communication system with which the present invention may be used for an email application.

FIG. 17 depicts the structure of a User Action History database as it relates to the primary fields needed to support the adaptation of the Screener and Ranker components of the Communications Controller.

FIG. 18 is a flow diagram depicting the components and message flow of the controller system operations.

FIG. 19 is a simplified system level diagram of a communication system with which the present invention may be used for a TV control application.

FIG. 20 is a flow diagram depicting the components and message flow of the controller system operations.

FIG. 21 depicts the structure of a User Action History database as it relates to the primary fields needed to support the adaptation of the Screener and Ranker components of the Communications Controller.

### DETAILED DESCRIPTION OF THE INVENTION

The disclosed Communications Controller virtually rids the receiving party/user of constant, non-value-added disruptions from any type of unwanted incoming communications (e.g., phone calls, Short Messaging Service (SMS) messages, Location Based Advertisement (LBA), Instant Messaging (IM) and/or electronic media, content, and email). Advantageously, the disclosed controller enables consumers to regain value-added control of their personal time and be selective of communications they encounter.

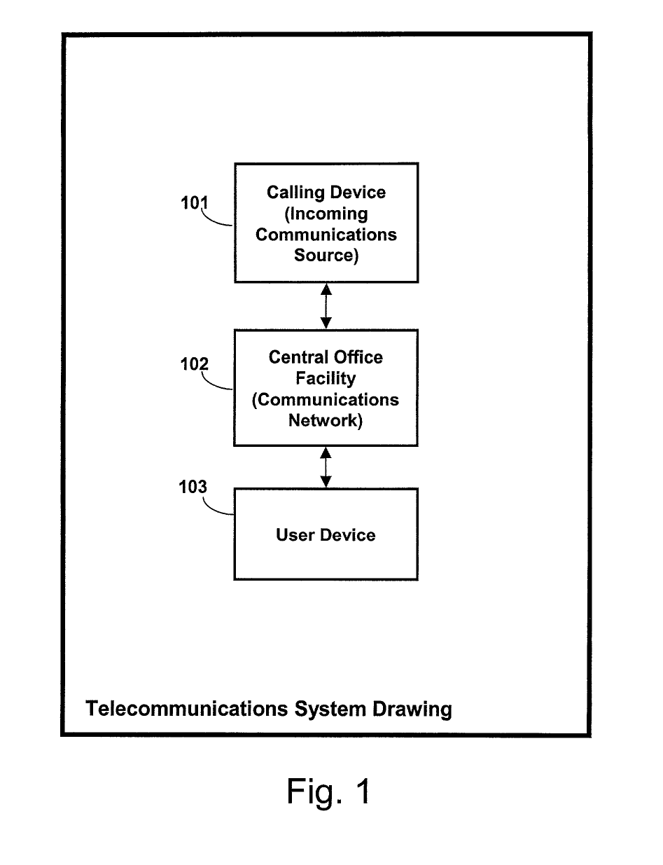

For purposes of illustration only, and not to limit generality, one embodiment of the Communications Controller will be explained with reference to its use in processing incoming telephone calls as one example of its application. The Communications Controller includes automated control logic that intelligently integrates proactive communication routing, screening, and selection functions for the user based on their behavior. The controller manages and controls incoming communications depending on the time-of-day, frequency, type, duration, mood of the user, learned user behavior, learned events, and priority rating of the received communication. FIG. 1 illustrates generally the relationship between calling and receiving devices in a telephone system and shows how the calling device 101 and receiving device 103 are distinct from a central office facility. The functions of the present invention are implemented in the receiving device and are independent of central office functions 102. It is noted however, that the Communications Controller could reside anywhere in the communications pipeline. This includes but is not limited to an adjunct box in the central office, a PBX, and consumer premises equipment such as a Personal Computer, and/or personal electronic devices such as a Personal Digital Assistant (PDA), Internet Appliance, a Home/Residential Gateway, a TV set-top box, automotive equipment, and/or wireless devices. The Communications Controller can essentially control any incoming communications in a communications system.

With application to the telephone embodiment, the disclosed Communications Controller enables the consumer to effectively control the time of day or night that a phone call is permitted to ring/announce an incoming call. It also permits the consumer to establish priorities for incoming calls and for the Communications Controller to sense their present mood. These priorities are then used to automatically route calls through the phone and to the consumer in a manner that suits the consumer's specific needs and values. If desired, unwanted incoming phone calls (e.g., from solicitors and harassers) will not even ring. Therefore, at the option of the receiving party, the receiving party is not disturbed. The disclosed controller advantageously transforms the telephone into a controllable device, which provides efficient and effective timely, value-added communication.

The disclosed communications controller is first described as it functionally relates to other telecommunication device functions. Later, representative hardware for implementing the controller is described in detail. While not shown in the drawing, it will be recognized that the conventional telephone system includes a plurality of user devices, e.g., telephones, which can communicate with each other via a telephone company central office switching facility. The term “telecommunications device” refers to a conventional telephone or other device enabling voice communication through such a central office or equivalent facility. Applicant's communication controller 100 is implemented in such conventional devices using computer software and hardware.

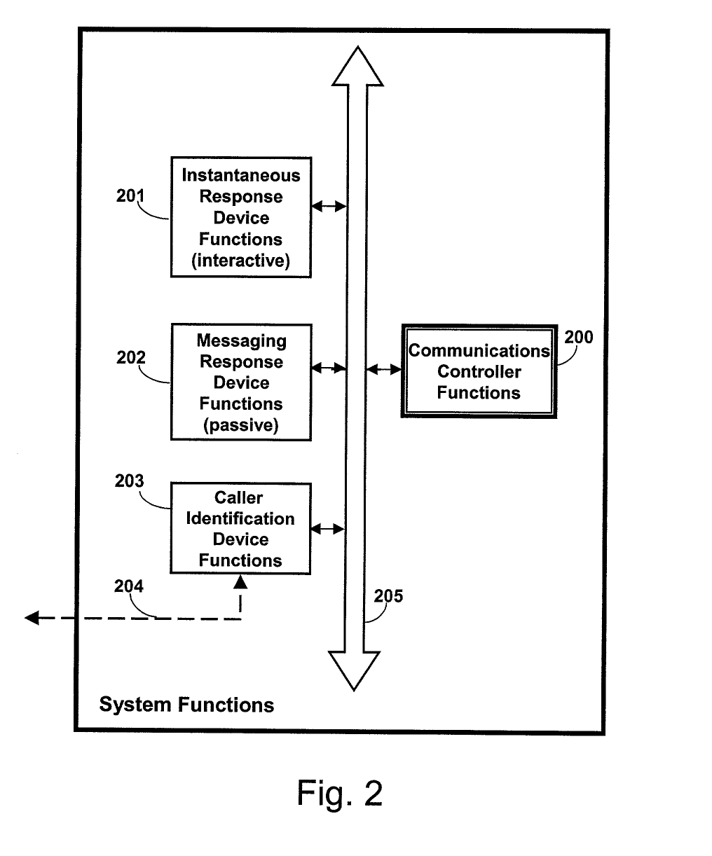

More particularly, FIG. 2 is a functional block diagram showing the overall relationship of the disclosed Communications Controller 200 relative to other telecommunication device functions. The processing provided to a particular incoming telephone call by the Communications Controller is time and incoming call priority dependent. It is noted that the Communications Controller and associative control logic can be applied and implemented as a consumer product along with other consumer telephony devices (e.g. telephones, answering machines, Caller ID devices, computers, telephone/television solutions). The Communications Controller can also be implemented at the telephone service switcher and provided to the consumer as a telephone service.

In one embodiment, the Instantaneous Response Device Functions 201, Messaging Response Device Functions 202, and Caller Identification Device Functions 203 may be implemented as an integrated device or independently to support the Communications Controller Functions 200 as indicated in FIG. 2.

The Instantaneous Response Device Functions 201 (e.g., telephone device) provides the interactive support needed for a communications device such as a telephone. Examples of the support this device provides are ring/announce, call forward, call waiting, and paging the user for immediate response to the incoming call.

The Messaging Response Device Functions 202 (e.g., answering machine) provides the passive support needed for a communications device. Examples of the support this device provides are to play, store, and record message data (e.g., voicemail, email, multimedia mail) to which the user can respond at their convenience but not necessarily during the time the call/contact is being placed or made. The communications line 204 (e.g., a telephone line or cable) that connects to other communication devices is coupled to the Caller Identification Device Functions 203.

The Caller Identification (ID) Device 203 sends incoming call data such as Caller ID data to Communications Controller 200. Communications Controller 200 processes incoming calls using the Caller ID data received. If the incoming Caller ID data is not available for a particular incoming call, then Communications Controller 200 uses Messaging Response Device (e.g. Answering Machine) Functions 202 to play an Out Going Message (OGM) prompting the caller for their identification data. Upon the Communications Controller 200 attempting to obtain this data, it will continue processing the call. As a result, the Communications Controller 200 will either use the:

1) Instantaneous Response Device Functions 201 to ring/announce via the telephone device, forward the call, page the person being called, support remote control of the device, terminate the call, notify the user of call waiting via a specific beep indication or,

2) Messaging Response Device (e.g., Answering Machine) Functions 202 to play an appropriate OGM and permit the caller to leave a message.

The interface 205 supports communications to transmit and route data among the above described system functions in FIG. 1.

Incoming Caller ID data can either be originating device dependent (identifier associated to the call origination device) or caller dependent (identifier associated to the individual caller/person). Consumer products for the Caller Identification Device Functions 203 using today's technology are device dependent—they provide the caller's phone number and/or name. However, depending on the application and implementation of the Communications Controller 200, this data could be the I.P. Address of a node on a network or other device identifier data. Conversely, caller dependent data can utilize such elements as:

1) Caller personal account data (e.g., account number, email address, Internet address, etc.);

2) Speaker dependent voice data—person identifying themselves by speaking their name in order to capture their temporal phonic signal data; and

3) Video data—a video frame of a caller's unique identifiers (e.g., the caller's face, retinal scan, finger/thumb print, etc.)

In this telephony embodiment, the Communications Controller 200 is not dependent on the Caller ID data/media type. Rather, controller 200 merely conforms to the data type being used by the Caller Identification Device Functions 203, which is an external interface to Communications Controller 200. Communications Controller 200 merely utilizes this data associated with the caller regardless of its type (e.g., device dependent or caller dependent) to determine the given priority of the caller. (Communications Controller 200 uses the incoming Caller ID data to attempt to match this data with the Caller ID data stored in its database for a call priority determination.)

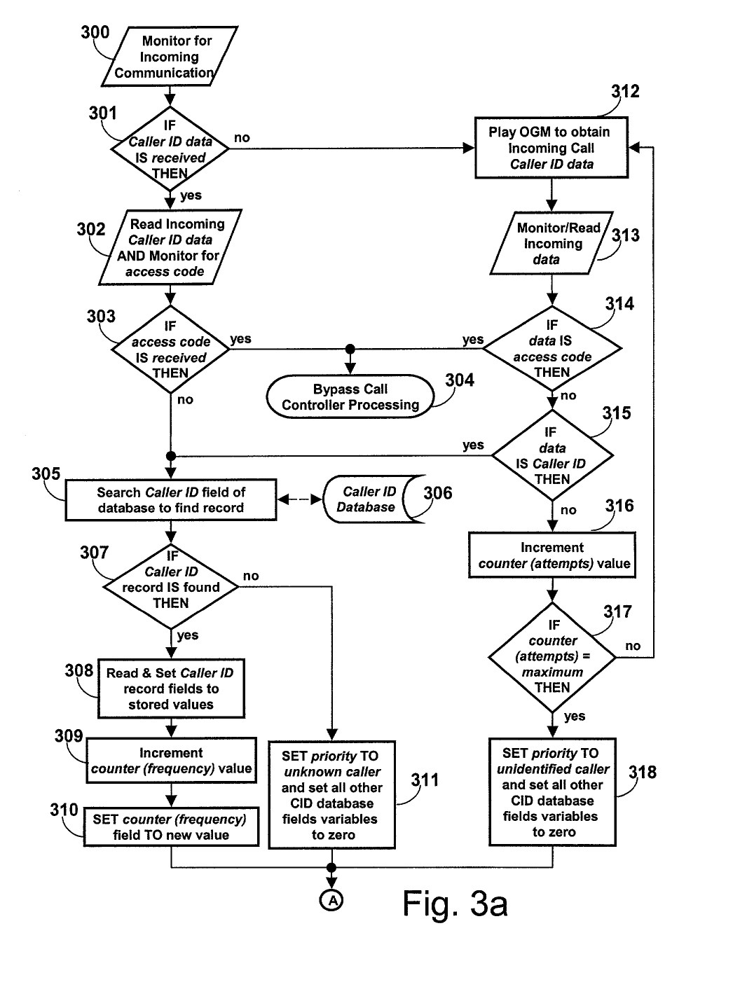

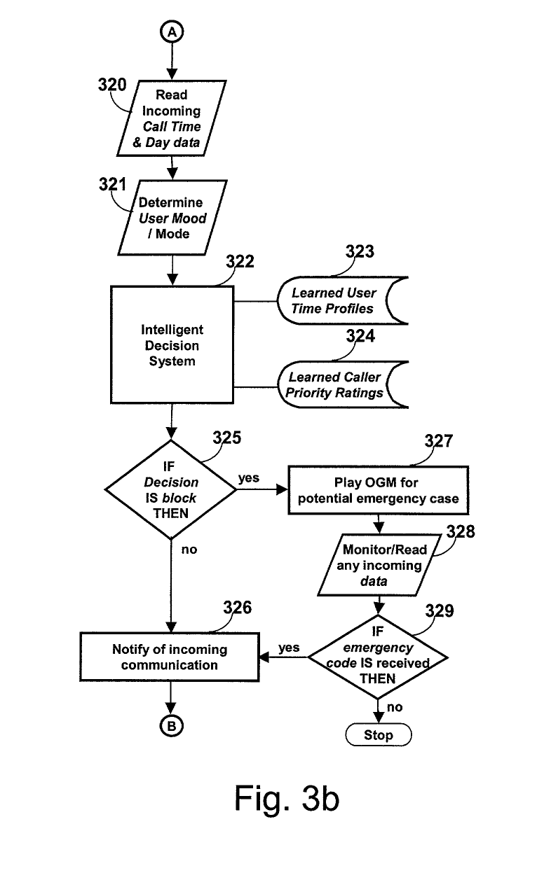

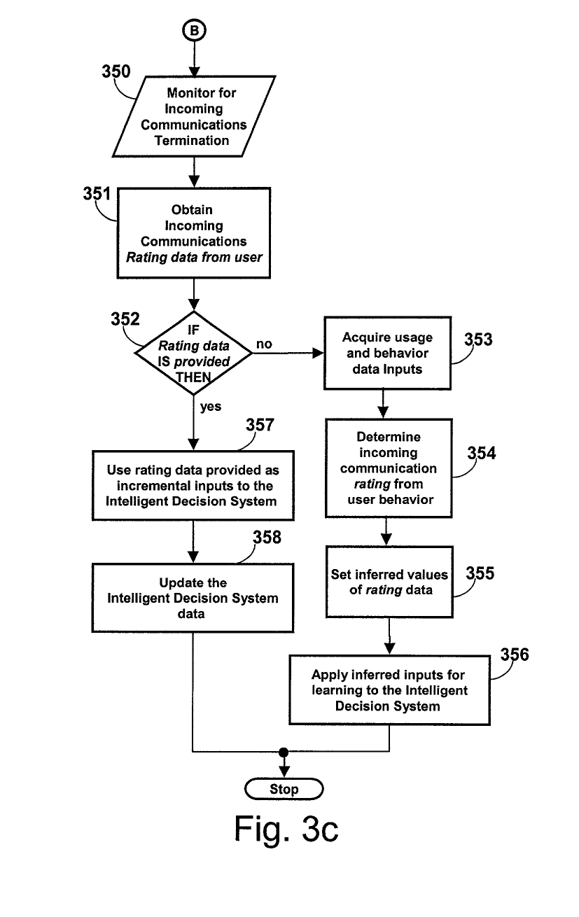

FIGS. 3a, 3b, and 3c together form a flow diagram depicting the flow of operations carried out by the Communications Controller 200 system. The steps shown in FIGS. 3a, 3b, and 3c provide an example of the control logic necessary to route and handle an incoming communication. Operation commences at the monitor for an incoming communication step 300, and upon the condition of an incoming call being received; a test is performed by Communications Controller 200 at decision block 301 to determine if the incoming Caller ID data is present. If the Caller ID data is present, it is read for further processing and monitoring for an access code input from the caller is performed at 302. A check is performed in 303 to determine if an access code is present. Upon receiving an access code, the Communications Controller logic is by-passed and the control of the call is routed directly to the Instantaneous Response Device 201 as indicated at bypass block 204. However, if the Caller ID data is not present, then at 312 an Outgoing Message (OGM) is played to request the caller to provide their Caller ID data. The Communications Controller 200 then monitors and reads the provided data as indicated at block 313.

A test is then performed at 314 to determine if an access code is present. Upon receiving an access code, the Communications Controller logic is by-passed and the control of the call is routed directly to the Instantaneous Response Device 201 as indicated at bypass block 304. However, if no access code is found at test 314, a check is performed at 315 to see if Caller ID data has now been provided by the caller. The Communications Controller 200 then monitors for Caller ID data to be received. If test 315 determines that Caller ID data is not received, the attempt to obtain Caller ID data from the caller is incremented 316. A check is performed at 317 to determine that the number of times the caller has been asked to provide their Caller ID is less than the maximum times permitted. If the maximum attempts are not exceeded, then Communications Controller 200 is programmed to send control information to the telephone device to hang-up or reiterate the request (OGM) to obtain the Caller ID information as indicated at block 312. This iterative process can reoccur a selected number of times based upon a maximum value. When the caller fails to provide valid Caller ID data after being provided with the maximum number of attempts, the priority of the phone call is set to an unidentified caller in block 318 to support further processing.

However, if test 315 finds that the caller has provided their Caller ID data, then a Caller ID database search is invoked at 305 on the Caller ID data field of Caller ID database 306. This search attempts to locate the record associated with matching Caller ID data field contents to the Caller ID currently determined. If the Caller ID match is found at matching test 307, then each field value of the matching record (for example: name, index, priority, OGM ID, announce ID, frequency, counter (frequency), duration and emergency operation) is read or obtained at 308 to support further processing. Then, the Counter(frequency) field is incremented at 309 and the new Counter(frequency) value is stored at 310 for further processing. (The purpose of this Counter(frequency) field is to provide the user with a pre-selected number of times a particular Caller ID can place a call over a specified period of time (say 24 hours) so as to limit being pestered by continuous calling from a particular caller.) If a Caller ID match is not found at 307, then the priority field value is set to indicate that the caller's identity (unknown caller) does not have a record associated to it in the Caller ID database 311. Also, all fields of a Caller ID record (for example: name, index, priority, OGM ID, announce ID, frequency, counter (frequency), duration and emergency operation) are set to zero to support further processing in block 311.

It is noted that the Caller ID data could either be caller dependent or device dependent. For example, the Caller ID data could consist of the originating call telephone number or I.P. Address for a network implementation for the device dependent data. Conversely, caller dependent data could consist of the caller video image data, speech pattern data, and/or personal account identification data.

Next, the current time and day data are read 320 to establish when the incoming communications is being received as indicated in FIG. 3b. This is performed by reading the internal clock time and day information of the Communications Controller 200. The Communications Controller 200 allows for mood and/or mode of communications to be controlled by the user. The current user's mood or mode of the Communications Controller is determined 321 as an input into the Intelligent Decision System 322. This is dependent on the implementation of using an overall device mode control or a mood control either of which can be selected by the user.

An example of the implementation using a device mode selection incorporates a user setting on a telephony device that to provide the overall device state. The user could set the device in a “normal mode”, “silent mode”, etc. This mode setting will influence the final operational control data that will be sent to other System Function(s) identified in FIG. 2. The mode could influence the control data as follows:

1) Normal Mode—let the Communications Controller function without any additional influences; and

2) Silent Mode—only let the highest priority communications notify me of an incoming communication and suppress all other communications;

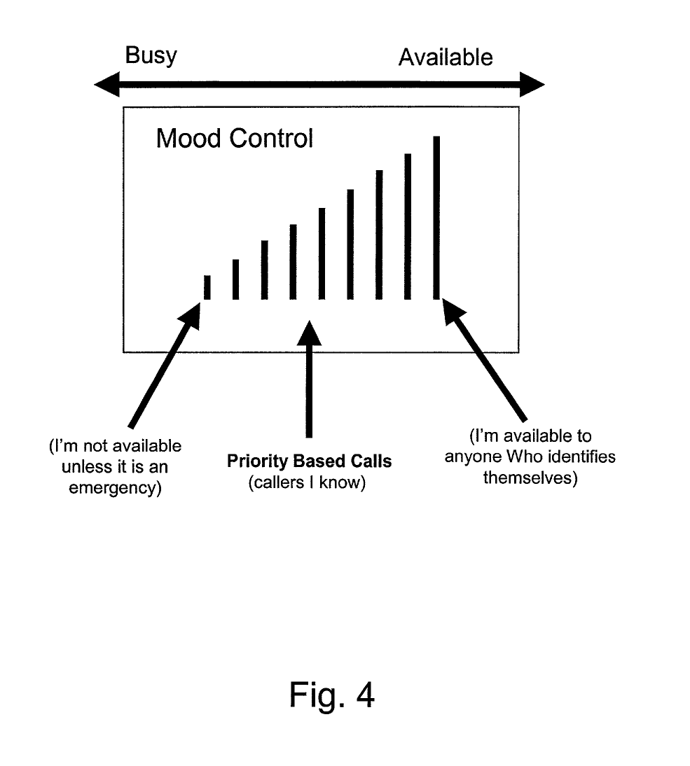

An example of the user mood implementation could be a sliding switch on a telephony device such as a cellular phone that provides the user with settings based on their immediate mood. This provides dynamic control of their incoming communications. As indicated in FIG. 4, this mood setting could have positions/indications for the following user moods:

1) I'm not available—I do not want to receive any incoming communication unless it is a true emergency,

2) I'm slightly available—I only want to receive incoming communications from people I really like and emergency communications,

3) I'm fairly available—I will communicate with anyone I know; and

4) I'm completely available—I will communicate with anyone that identifies himself or herself and want to be reached.

The Intelligent Decision System 322 uses Learned User Time Profiles 323 data and the Learned Caller Priority Ratings 324 data to determine the disposition of the incoming communication. If the decision is to “block” the incoming communication 325, then an OGM is played to prompt the caller to indicate if the call is an emergency 327. Check 328 is made to determine if an emergency code has been received. If no emergency code is received 329, the call will be possessed with a “blocked” condition. However if the caller has indicated that the communication is an emergency condition, the call that would normally have been blocked is permitted to notify the user that they have an incoming communication with an emergency condition 326. If the decision is not to block the incoming communication 325, then the call is permitted to notify the user that they have an incoming communication 326.

An important application of this invention is delivering adaptive and individualized screening of incoming communication like telephone calls. FIG. 3c depicts an implementation to obtain a communication priority or rating from the Communications Controller 200 user's incoming communication priority rating processing. This representation is for the telephony embodiment where the user rates (i.e., determines the priority of the caller) the incoming communication, in this case the call they just terminated, in order to provide customization for future incoming communications. This will provide feedback to the Communications Controller 200 on if the user liked the phone call or not and how much they like it. This rating feedback permits the Communications Controller 200 to infer if the user desires to receive any further communications from this particular caller or not. It provides a methodology to infer the priority of a caller and if the user wants to receive future calls from this particular caller at the time they just received the call. To ensure the Communications Controller is dynamically adaptive to the user and can be customized without extensive programming, the call rating feedback will enable the device to adapt its function based on learned behavior patterns. The Communications Controller learns user behavior patterns based on usage of the device and feedback provided by the user. The Communications Controller observes interaction of the user with the device to store an internal representation of the user's preferences, adapting the device to the user. The results of this method will produce an intelligent user interface that requires little to no programming on the user's behalf.

As indicated in FIG. 3c, the device processing will monitor for a communications termination 350 (i.e., a change in device state from “off-hook” to the “on-hook” state for telephone). Upon determination that the communications is complete, the device will prompt the user for a priority rating of the communication just terminated 351. If the user provides the rating data 352, the incoming communications priority rating is set to the new rating and provided as an input to the Intelligent Decision System 357 for processing of future incoming communications from this caller in this instance. Then the Intelligent Decision System 358 processes the new data and stores updated information for future processing.

However, if the user does not choose to rate the communications just terminated 352 then, the usage and behavior data 353 are used as inputs for the determination of incoming communication rating 355. These inputs consist of data collected during the communication and behavior data from usage of the device. More particularly in the telephony example of input types would be the following data:

1) Communications duration (e.g., how long did the user communicate with the caller),

2) Frequency data (e.g., how often does the user communicate with the caller), and

3) Stress (e.g., was the user talking very loud during most of the conversation).

This technique is applied equally well for any incoming communication. For example, in modeling a user's web site preference, direct user rating feedback may provide the target (a.k.a. dependent variable) values, while number of visits, length of viewing, etc. may provide the predictor values.

These data inputs would be used to determine the incoming communication priority rating 354 based on the user behavior 353 yielding a confident factor. This confidence value indicates the amount of reliance that can be put on the current rating being determined. This confidence value is determined by statistical characteristics of the learning data with respect to the current predictor values. The predictive model could also be a neural net that uses the data inputs to determine the communication rating based on the user's behavior. Once the rating is determined 355, the rating is inputted to the Intelligent Decision System 356 and the communications rating processing is terminated 357.

The Intelligent Decision System 356 uses short-term and long-term temporal models to discriminate short-term behaviors related to mood and transient behaviors from more long-term behaviors and preferences. The system uses both direct feedback from the user and unsupervised observation of the user's interactions with the device. Direct feedback is obtained by providing a method whereby the user rates his experience as either positive or negative to some degree. Indirect feedback is obtained by observing usage patterns without such a rating. The internal models constructed by these methods are used to modify the behavior of the device to provide a more individualized experience. The more times the buttons are pressed the more positive or negative call is rated. This information is used by the behavior profiling system to change internal parameters in both short-term and long-term memory. In the telephony application, an accumulation of negative feedback for over a short period of time would be used to eliminate pest callers, while long-term negative accumulation would cause longer-term prohibition of those callers.

An embodiment of the telephone screening application would apply a correction to the long-term and short-term ratings of a caller using an exponential decay according to the following formulae:

$${Rating}_{new} = {Rating}_{old} + f ( t ) \cdot ( {Rating}_{entered} - {Rating}_{old} )$$

$$f ( t ) = \frac{2}{1 + {e}^{- t / τ}} - 1$$

where t is the time since the last update and τ is a time constant determining the decay rate. For long-term rating, the time constant might be set to a number of days, whereas the short-term time constant may be hours. This method maintains both short-term and long-term moving averages with a minimum of storage and computation and allows a versatile characterization of user mood and preference.

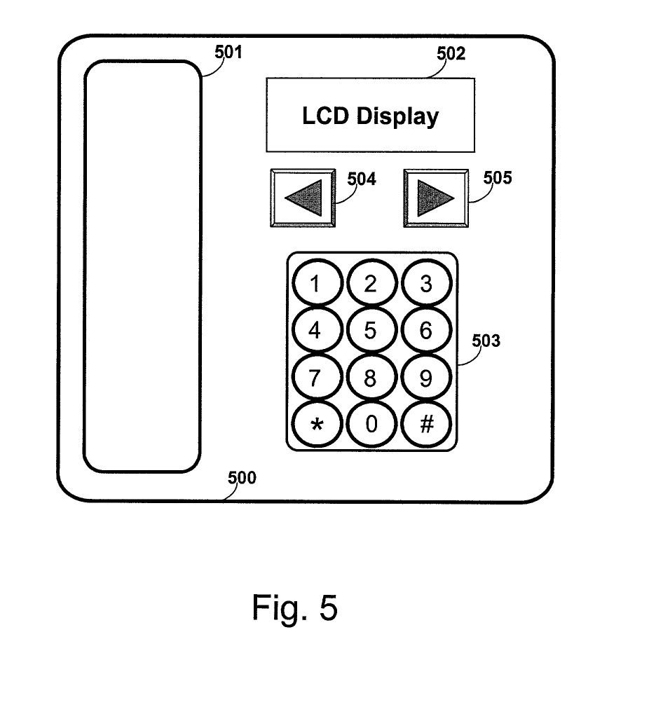

Specific implementation representation on a telephone could be to add two buttons to the normal telephone keypad as depicted in FIG. 5 where 500 is a typical telephone device system 500 with a handset 501, LCD display 502, and keypad 503. One button would be used to provide positive feedback after a call was received 505; the other would provide negative feedback 504. After a received call the user would press the positive feedback button to indicate a pleasant experience, or the negative button to indicate a negative experience.

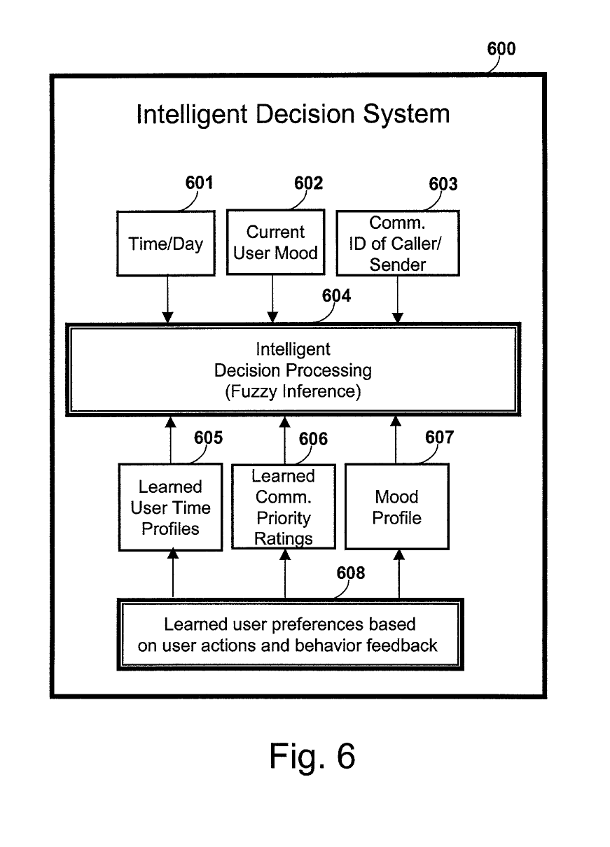

FIG. 6 details the Intelligent Decision System 600. The purpose of this system is to make intelligent proactive personalized decisions for the user in a dynamic environment by inferring desired communications control based on learned user preferences/behavior and prior user inputs/feedback. Results of this processing will determine the disposition of a current communication. The Intelligent Decision Processing 604 is based on a Fuzzy Inference System that uses the current time and day data 601 (i.e., detailed in FIG. 3b), the current user mood (or mode of the device which is application dependent as detailed earlier) 602, and the current communications identification 603 (e.g., caller id for the telephony embodiment) as crisp inputs. These crisp inputs are used by the Intelligent Decision System 600 to make a proactive communications control determination for the current communication being processed.

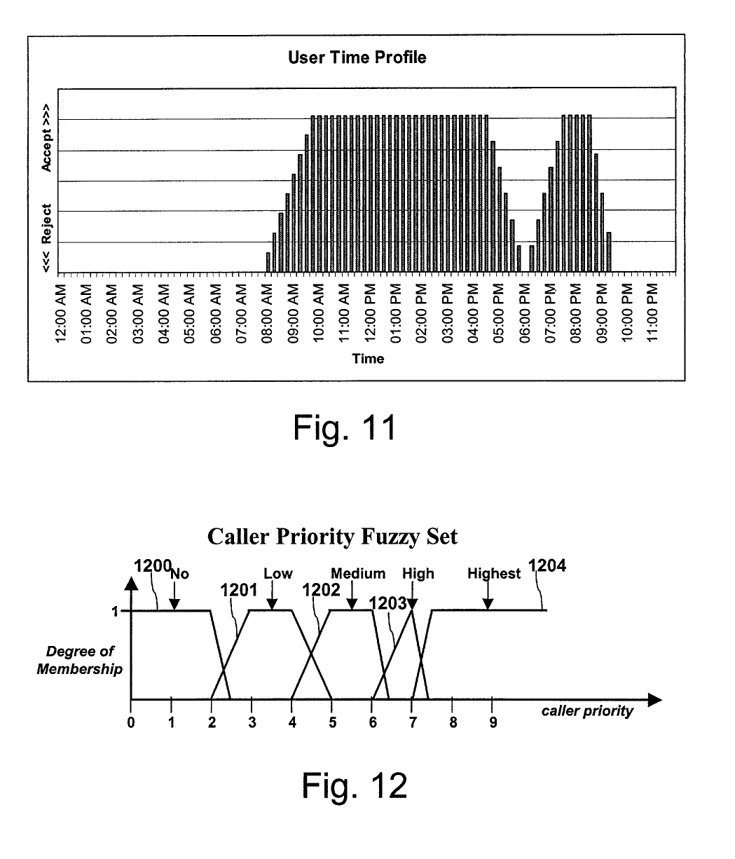

A user's availability is time dependent (e.g., not typically available during late night/early morning hours). The Learned User Time Profiles 605 represents one type of the membership function sets used by the Intelligent Decision Processing 604 (see FIG. 11 for further details of the time membership function set). The user's availability may also be inferred based on schedule information (e.g., the schedule inputted as in or via a PDA or another source that provides schedule/event information). The time profile can also be inferred based on how the user has rated the reception of prior calls for a particular time. If a user rates the reception of calls poorly for a particular period of time then the inference is to reflect that the user does not desire to receive communication during this time.

The intent of this invention is to provide selective personalized incoming communications for the user. A learned communications priority rating membership function 606 represents another type of membership function set used by the Intelligent Decision Processing 604 to accommodate relative communications priority ratings (see details in FIG. 12). Ratings of communications can be captured as feedback inputted by the user as described in FIG. 3c or inferred based on the user's actions 608 since the system uses both direct feedback from the user and unsupervised observation of the user's interactions with the device. Direct feedback is obtained by providing a method whereby the user rates his experience as either positive or negative to some degree. Indirect feedback is obtained by observing usage patterns without such a rating. The internal models constructed by these methods are used to modify the behavior of the device to provide a more individualized experience. The more times the buttons are pressed the more positive or negative call is rated. This information is used by the behavior profiling system to change internal parameters in both short-term and long-term memory. In the telephony application, an accumulation of negative feedback for over a short period of time would be used to eliminate pest callers, while long-term negative accumulation would cause longer-term prohibition of those callers. If the user does not choose to rate the communications then, the usage and behavior data are used to infer inputs for the determination of incoming communication priority rating. These inputs can consist of data collected during the communication and behavior data from usage of the device such as:

1) Communications duration (e.g., how long did the user communicate with the caller),

2) Frequency data (e.g., how often does the user communicate with the caller), and

3) Stress (e.g., was the user talking very loud during most of the conversation).

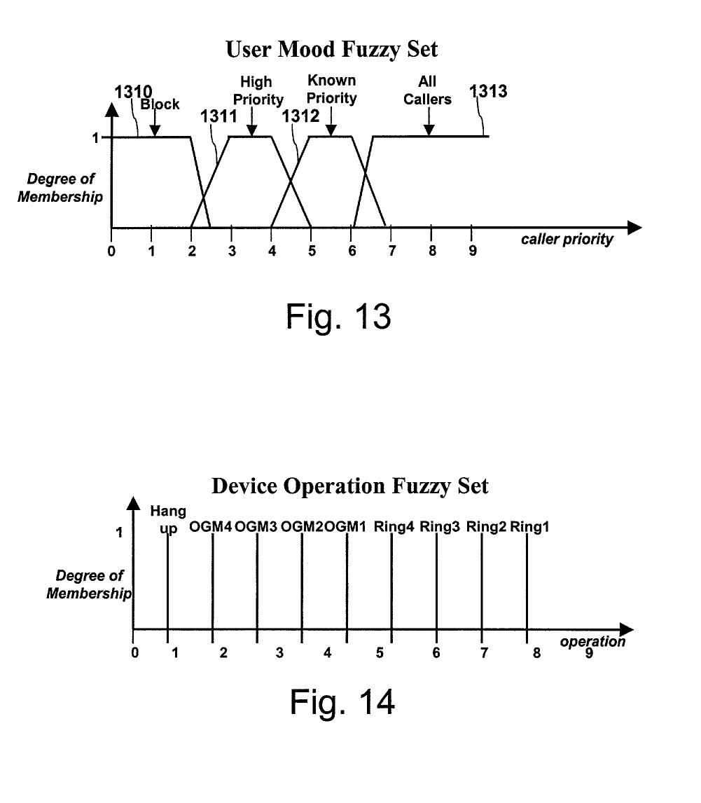

The Intelligent Decision System 600 is also influenced by the user's mood or mode of operation of the communications device. The user's mood profile 607 is a membership function set (see FIG. 13 for details) that is intended to represent if the user is currently in the mood to communicate.

Feedback to modify and update the membership function sets 605, 606, and 607 is provided based on user actions (e.g., historical usage of the communications device) and the user's behavior feedback (e.g., rating the communications by the user).

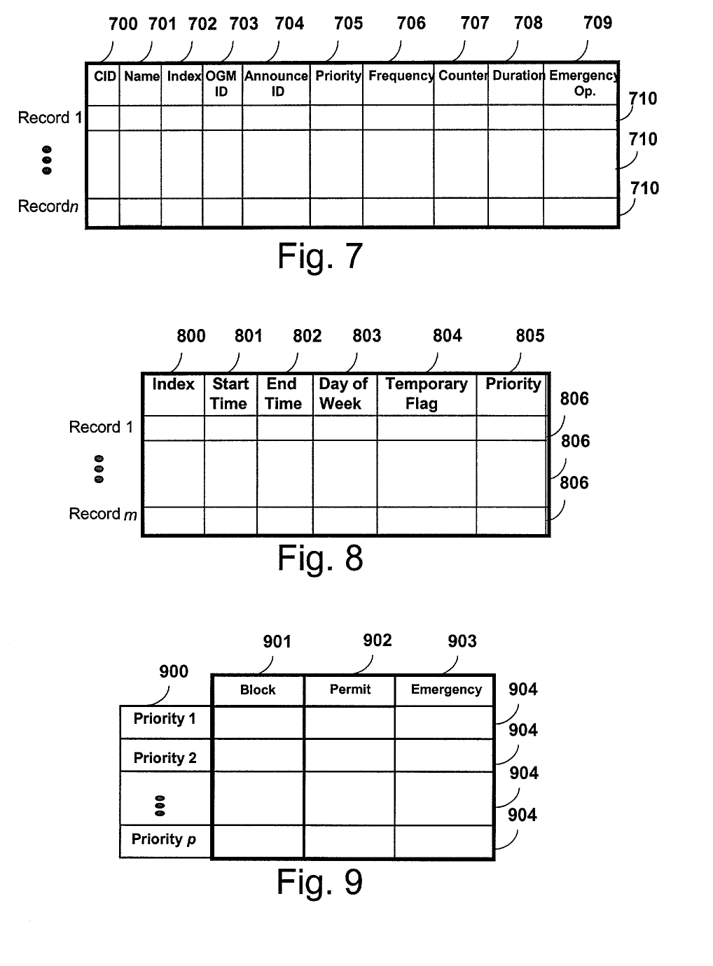

FIG. 7 depicts a caller database structure employed in one embodiment of the disclosed Communications Controller. The purpose of this database is to provide the Communications Controller with storage of incoming Caller ID data associated with the user's set priority data for that particular caller type. This database structure is employed by the earlier discussed Caller ID database search of FIG. 3a to obtain the priority of the incoming call.

This caller database structure includes a plurality of records 710 that are designated as Records 1 . . . n. As shown in FIG. 7, each record includes an incoming Caller ID (CID) field 700; a caller name field 701; an index field 702; an OGM ID field 703; an Announce ID field 704; a caller Priority field 705; a Frequency field 706 which contains the set limit or maximum number of times the caller can potentially ring through over a selected period of time; a Counter field 707 which cooperates with the Frequency field 706 to track the number of times a particular caller has placed a call within the selected period of time (e.g., 24 hours); a Duration field 708 (the duration field supports the user selected amount of time they typically allot to speak with a particular caller so as to budget their time); and an Emergency operation field 709 (this field contains the consequential telephone operation control data to be used for the conditions it supports).

The incoming Caller ID 700 is the unique identifier for the incoming call. With today's technology, the Caller ID is the call origination phone number. However, alternatively Caller ID 700 could be supported by speech/voice recognition data (namely unique speech or voice information), and/or image processing data (unique picture information) as well. The caller name field 701 can be used to store the name associated with the incoming Caller ID 700. The index field 702 is used for maintenance of the Communications Controller 200. Upon the database memory becoming inadequate to store additional records 709, the Communications Controller 200 can select a candidate based on which record is the lowest priority and is the most dormant per the index 702 indication. This candidate record memory allocation can then be used to store new data in these fields. The OGM ID 703 field contains an identifier for a specific OGM to be played for the particular Caller ID data. The Announce ID 704 field also contains an identifier for a specific Announcement to be played for the particular Caller ID data. The priority field 705 is used to store the relative priority of a Caller ID based on the user's needs/selection. For example, a representation of relative priorities is given in the following TABLE 1 wherein Priority 1 is the lowest priority and Priority 8 is the highest priority:

TABLE 1

Priority 1 - harassment (lowest priority)
Priority 2 - solicitations
Priority 3 - friendly but not in the database
Priority 4 - vendors/affiliations
Priority 5 - work/business
Priority 6 - secondary friends
Priority 7 - primary friends/distant family
Priority 8 - close family (highest priority)

FIG. 8 depicts a blocking time database structure employed by one embodiment of the disclosed Communications Controller 200. This blocking time database structure is used by test 408 of FIG. 4 to determine if the incoming call is to be blocked or permitted based on the time of the call being received. The database structure includes a plurality of records 806 designated as records 1 . . . m. Each record defines a time block interval, namely an interval of time that the user does not wish incoming calls of specified priority to cause their telephone to ring or announce the caller.

Each of records 1 . . . m includes an index field 800, a block time interval start time field 801, a block time interval end time field 802, a day of the week field 803, a temporary flag 804, and the priority field 805. The index field can be used for internal Communications Controller 200 processing. The start time field 801 provides the hour and minute the time block interval begins. The end time field 802 provides the hour and minute the time block interval ends. The day of the week field 803 provides the days during the week that the time block interval is active. The priority field 805 is used to store the relative priority of a caller based on the user's needs. For example, a representation of a time block interval could be from 10:00 p.m. to 5:00 a.m., Sunday through Friday, blocking all priorities except Priority 8—family callers. The temporary flag field 804 is the flag that indicates the time block interval is temporary. This flag supports the silence mode of this invention. The Silence mode permits the user to select a relative period of time to block their phone calls. For instance, the next 2 hours put all calls in the block mode with user selected call priority exceptions.

FIG. 9 depicts a representative lookup table structure employed in the disclosed Communications Controller 200. The lookup table structure is used by the notify of incoming communication 326 of FIG. 3b to obtain the consequential operation control data for the integrated telephone device functions. These consequences are based on conditional results being present. In particular, the lookup table structure includes a plurality of records 904 designated 1 . . . p, which is dependent of the number of caller priorities employed an any particular embodiment of Communications Controller 200. For example, in the disclosed embodiment wherein Priorities 1-8 are referenced in Table 1 above, p would have a value of 8.

With the combined conditions of the call being placed during the block time 901 and the priority 900 of the incoming call being specified, the desired consequential operation of the telephone device is defined. (It should be recalled that the controller retrieves the block time information from the blocking time database of FIG. 8 and that the controller retrieves the priority of the incoming call from the caller database of FIG. 7.) With the combined conditions of an emergency call being placed during the block time 903 and the priority 900 of the incoming call being specified, the desired consequential operation of the telephone device is defined. Again, with the combined conditions of the call being placed during the permit time 902 and the priority 900 of the incoming call being specified, the desired consequential operation of the telephone device is defined. The operations of the telephone device include the Caller Identification Device Functions 203, Messaging Response Device Functions 202, and Instantaneous Response Device Functions 201. Some of these operations include but are not limited to the following:

Provide a specified ring pattern (of multiple ring pattern options)

Provide a specified announcement for a particular caller

Provide a specified OGM with or without an opportunity for the caller to leave a message (of multiple OGM options)

Terminate the call (e.g., hang-up without ringing the telephone device)

Call Forwarding/paging upon a call being routed to ring and the user pre-selecting this option

Call waiting will transmit a beep signal for the user while on the phone. This beep could be mapped to a priority level beep type to inform the user of the importance of the call prior to them disrupting their present conversation

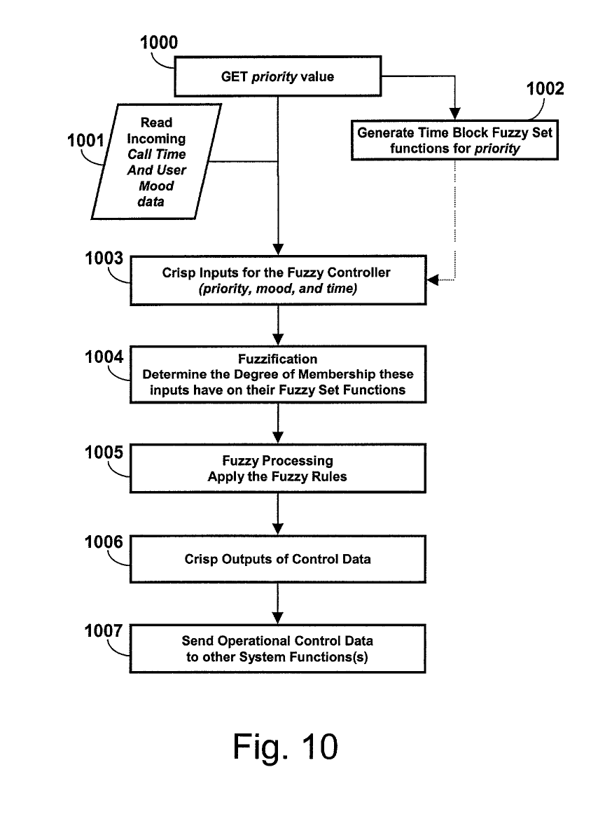

The Communications Controller 200 control methodology employs Fuzzy Inference Logic (FIL). FIG. 10 depicts the flow diagram of the unique processing required to support a preferred embodiment of the FIL processing. The priority is obtained at step 1000 and the call time and user mood data are obtained at 1001. Then fuzzy set membership functions are generated for that particular caller priority 1002. The crisp values for the caller priority, mood, and time are obtained at 1003 and are used to operate on the fuzzy sets of the FIL. This fuzzifies the data to a degree of membership relative to the values as indicated at step 1004. Then, FIL rules are applied at 1005. The rule that yields the strongest result is considered the consequential functional operation that the device should perform which is mapped to the crisp outputs as indicated at 1006. This output operation control data is then routed to the other telephone functions at 1007.

By way of example, the FIL implementation could utilize 3 conditional fuzzy sets. One conditional fuzzy set is for the block time conditions for a particular priority, a representation of which is shown in FIG. 11. A second conditional fuzzy set is the relative caller priority as depicted in FIG. 12.

The crisp inputs to this FIL are:

1) Relative values of actual time of call in hour/minute/day data

2) Relative value of caller priority as pre-selected by the user this example employs the following associated crisp values:

1=Priority 1—harassment (lowest priority)

2=Priority 2—solicitations

3=Priority 3—friendly but not in the database

4=Priority 4—vendors/affiliations

5=Priority 5—work/business

6=Priority 6—secondary friends

7=Priority 7—primary friends/distant family

8=Priority 8—close family (highest priority)

For a particular caller priority, the block time interval functions are generated based on the duration of the time interval. As seen in FIG. 11, one approach for achieving the time block interval functions is to have the function possess a degree of membership of 1 for 90% duration about its center between 1102 and 1103. The remaining 10% of the duration is divided between the intervals of between points 1101 to 1102 and 1103 to 1104. For example, if the block times interval started at 9:00 p.m. and ended at 6 a.m. yielding duration of 540 minutes, 90% of this interval is duration of 486 minutes 1102 and 1103, which would possess a degree of membership of 1. The remaining 54 minutes divided by 2 yields 27 minutes duration. For the starting point of the resulting function, the degree of membership is 0 ramping to a degree of 1 within the 27-minute duration 1101, 1102. For the ending point, the degree of membership is 0 at the end point of the block time interval and 1 within the last 27 minutes of the block time interval. Conversely, the permit time interval functions can be generated applying this same logic.

FIG. 12 depicts a representation of the Caller Priority Fuzzy Set. This Fuzzy set possesses the membership functions as they relate to the crisp priority input values. This representation maps the caller priority to the following relative incoming call conditions:

No priority 1200

Low priority 1201

Medium priority 1202

High priority 1203

Highest priority 1204

A third conditional fuzzy set would be used if the user's mood to receive communications is reflected in the Communications Controller logic. A representation of the Mood Fuzzy Set is depicted in FIG. 13. This representation maps the various moods of the user to the following relative mood conditions:

Block Calls (Not in the mood to receive calls) 1300

High Priority Calls (Only receive calls from people with the highest priority) 1301

Known Callers (Receive calls from anyone I know) 1302

All Callers (Receive calls from anyone who identifies themselves) 1303

For simplicity, this example utilizes a Singleton output Fuzzy set for the consequential functional operations as shown in FIG. 14, which yields crisp outputs as follows:

1=hang-up=no priority call

2=OGM4=low/no priority OGM message

3=OGM3=medium priority OGM message

4=OGM2=high priority OGM message

5=OGM1=highest priority OGM message

6=Ring4=low priority ring pattern

7=Ring3=medium priority ring pattern

8=Ring2=high priority ring pattern

9=Ring1=highest priority ring pattern

It is noted that this Singleton crisp logic is directly applicable to the software implementation of FIGS. 3a, 3b, 3c, and 6. Also, other elements could be added to this Singleton such as the beep pattern type for different priorities of call waiting.

A representative subset of Fuzzy Rules for these conditional Fuzzy Sets excluding the Mood Fuzzy Set is as follows:

if Time is Block and Priority is No then Operation is Hang-up;

if Time is Block and Priority is Low then Operation is OGM4;

if Time is Block and Priority is Medium then Operation is OGM3;

if Time is Block and Priority is High then Operation is OGM2;

if Time is Block and Priority is Highest then Operation is OGM1;

if Time is Permit and Priority is No then Operation is OGM4;

if Time is Permit and Priority is Low then Operation is Ring4;

if Time is Permit and Priority is Medium then Operation is Ring3;

if Time is Permit and Priority is High then Operation is Ring2;

if Time is Permit and Priority is Highest then Operation is Ring1;

A representative subset of Fuzzy Rules for the conditional Fuzzy Sets including the Mood Fuzzy Set is as follows:

if Time is Block and Priority is No and Mood is Block Calls then Operation is Hang-up;

if Time is Block and Priority is Low and Mood is Block Calls then Operation is OGM4;

if Time is Block and Priority is Medium and Mood is Block Calls then Operation is OGM3;

if Time is Block and Priority is High and Mood is Block Calls then Operation is OGM2;

if Time is Block and Priority is Highest and Mood is High Priority Calls then Operation is Ring1;

if Time is Permit and Priority is No and Mood is High Priority Calls then Operation is OGM4;

if Time is Permit and Priority is Low and Mood is All Callers then Operation is Ring4;

if Time is Permit and Priority is Medium and Mood is All Callers then Operation is Ring3;

if Time is Permit and Priority is High and Mood is Known Callers then Operation is Ring2;

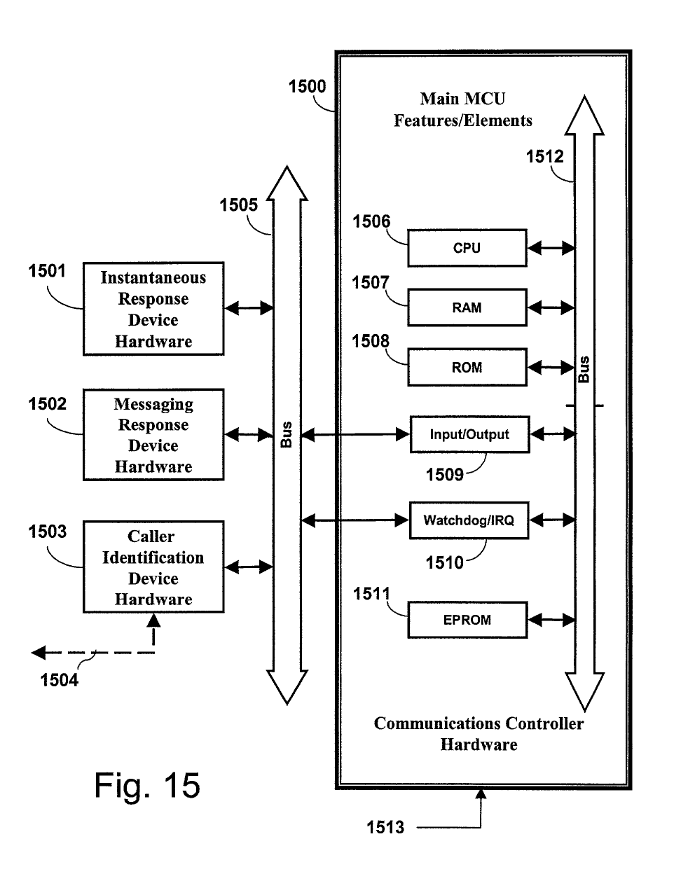

For the purpose of discussion, and not for the purpose of limitation, FIG. 15 depicts a high level hardware implementation of the FIG. 1 Communications Controller as Communications Controller 1500. Controller system 1500 employs a microcomputer (MCU). Utilization of a MCU for this type of application is a typical solution/implementation. However, the functions indicated in FIG. 2 can be integrated together or packaged separately in numerous configurations. These configurations can range from MCU's to Personal Computer Systems and/or a Telephony/Television System.

To clearly describe the hardware support functions required for the Communications Controller 1500 of FIG. 15, the following example of the steps performed upon receiving a call is explained along with details as they relate to the hardware of Communications Controller 1500. Communications Controller 1500 is coded with software according to the flow diagrams. This software code is stored in memory within controller 1500 in one embodiment. When executed by controller 1500, this software causes controller to implement the steps set forth in the flow diagrams.

Data is received and transmitted across the Bus 1505 to permit the Instantaneous Response Hardware 1501 (e.g. a telephone), the Messaging Response Hardware 1502 (e.g. an answering machine) the Caller Identification hardware 1503, and Communications Controller 1500 to communicate.

Upon receiving a call via the communications line 1504, the Caller Identification hardware 1503 receives the incoming Caller ID data. An interrupt is then generated from the Caller Identification Hardware 1503 and sent to the Communications Controller Watchdog/IRQ 1510. This Watchdog/IRQ 1510 (e.g. an interrupt controller) monitors for reception of an interrupt that designates a call is being received. After this interrupt, the Caller ID data is transmitted from the Caller Identification Hardware 1503 via the bus 1505 to the Communications Controller MCU Input port(s) 1509. The data is transmitted via the internal Bus 1512 to the MCU RAM 1507.

This Caller ID data is then compared against data stored in ROM 1508 to obtain priority information as explained in the description of FIGS. 3a, 3b, and 3c flow diagrams. CPU 1506 performs the processing software execution, which in turn provides the control logic for the controller according to the described flow diagrams. The RAM/ROM 1507/1508 provides the memory necessary to support the load of the executable code and memory to support the real-time processing. The EPROM 1511 provides the storage necessary to support the caller database of FIG. 7 and the blocking time database of FIG. 8 as well as the look up table of FIG. 9. The internal bus 1512 is used to support “local” communications among the various functions within the Communications Controller 1500.

In one embodiment, input values such as user selected priority and blocking time intervals are provided to communication controller 1500 by the user inputting such values to the Instantaneous Response Hardware 1501 (e.g. telephone device). These values are then transmitted to Communications Controller 1500 for storage in the memory therein. Alternatively, an input device such as a keyboard device or personal computer can be coupled to communications controller 1500 at input port 1513 to provide input for such values.

Another embodiment of the Communications Controller is disclosed with reference to its application in processing incoming email or text messages. The Communications Controller includes automated control logic that intelligently integrates communication routing and screening functions of the email. The controller manages and controls incoming communications depending on the time-of-day, frequency, type, duration, learned behavior, and priority rating of the received email communication.

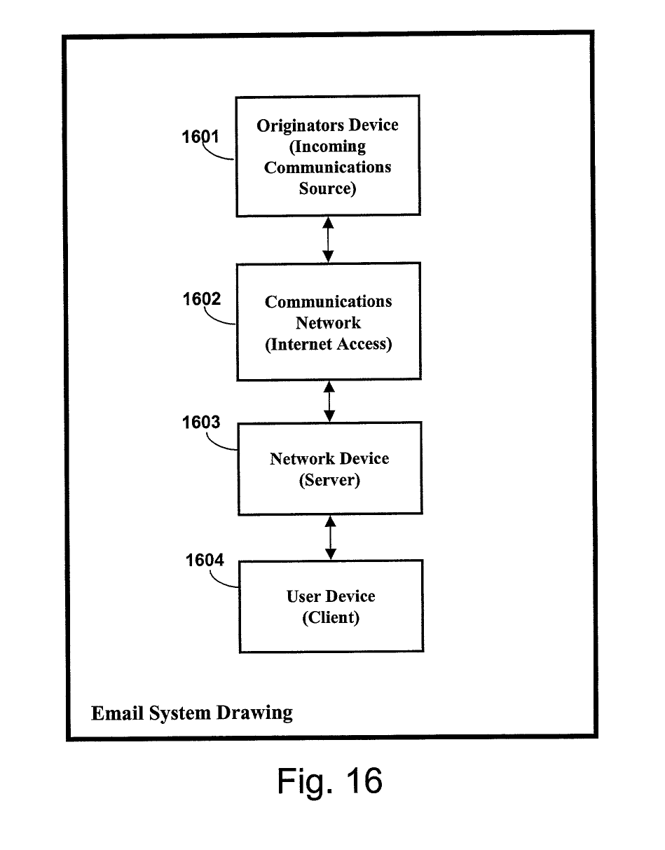

As depicted in FIG. 16, this embodiment implements the Communications Controller in the user's email device (client) 1604 however; the functions of the present invention may be implemented in the email client software or at any other point in the communications stream. The disclosed Communications Controller in this embodiment is described as it functionally relates to other email client functions. The term “email client” refers to an email software client application connected to email servers 1603 via a communication network 1602. The email or text message originator's device 1601 is also connected to the communications network 1602. Applicant's communication controller 200 is implemented in such an email client is using computer software and hardware.

The Communications Controller enables the consumer to effectively control the acceptance and presentation of incoming email. It also permits the consumer to establish priorities for incoming messages. These priorities are then used to automatically present messages through the email client's display software to the consumer in a manner that suits the consumer's specific needs and values. If desired, unwanted incoming messages (e.g., from solicitors and harassers, a.k.a. “Spam”, potential sources of viruses, potential sources of inappropriate content based on user's values, etc.) will not even be shown to the recipient. Therefore, at the option of the receiving party, the receiving party's time is not wasted. The Communications Controller advantageously transforms the email system into a controllable solution, which provides efficient, and effective timely, value-added communication.

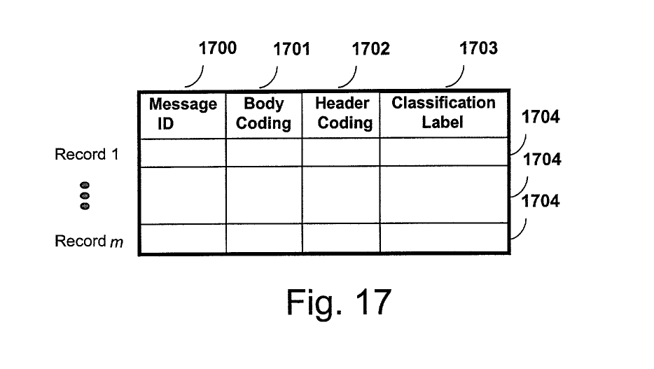

As shown in FIG. 17, the User Action History database structure includes a plurality of records 1704 that are designated as Records 1 . . . m. Each record includes a message ID field 1700; a body coding field 1701; a header coding field 1702; and a classification label field 1703.

The message ID 1700 is the unique identifier assigned to each incoming message. The body coding field 1701 is used to store a coding of the content of the message body. The header coding field 1702 is used to store information contained in the message header as well as auxiliary data such as the time of day the message was acted upon. Upon the database memory becoming inadequate to store additional records 1704, a portion of the database is reduced in size by using data clustering methods. The classification label field 1703 contains an indicator for a specific action the user applied to this message.

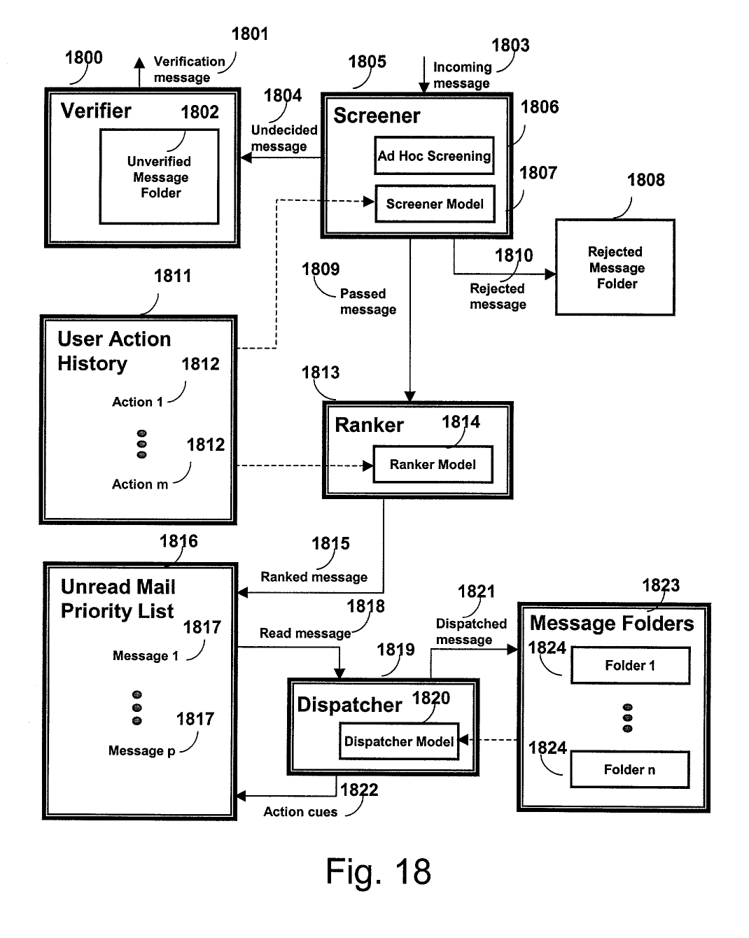

Processing for this embodiment is depicted in the flow diagram of FIG. 18. An incoming email message 1803 is first handled by the Screener 1805, which decides, based on ad hoc screening 1806 and a screener model 1807, whether the message should be routed as a passed message 1809, a rejected message 1810, or an undecided message 1804. The ad hoc screener 1806 uses heuristic methods based on foreknown expert knowledge to make a passed/rejected decision. For example, if it is known that a certain email source is a Spam violator, messages from that source may be rejected. The particular data employed in the ad hoc screener may be updated periodically in the form of software updates. The screener model 1807 is an adaptive component of the screener 1805, using the user action history 1811 to adapt its decisions to the user's preferences.

The user action history 1811 records data corresponding to specific actions taken by the user. For example, if the user examines a message and determines the message to be objectionable, he may indicate this using the client's user interface. This action would cause a new record 1812 to be created, containing the objectionable message's ID 1700, a coding of the message body 1701, a coding of the message's header 1702, and a classification label 1703 corresponding to the negative response of the user. Alternatively, if the user had responded positively to the message, a similar record 1812 would have been created, but with a classification label 1703 corresponding to a positive response. Over time, this record of user actions comprises a data source to be used for tuning the screener model 1807 and the ranker model 1814. This functions to adapt the operation of screening and ranking messages to the demonstrated preferences of the user.

If the screener 1805 decides to reject an incoming message 1803, the rejected message 1810 is sent to the rejected message folder 1808 for storage. The user may choose to review messages stored in this folder, or may simply discard the contents periodically. By simply allowing the contents of this folder to be discarded, the recipient is freed of the time-wasting task of reviewing and manually discarding unwanted email messages.

If the screener 1805 makes and indeterminate decision that a particular message should be passed or rejected, the undecided message 1804 is routed to the verifier 1800 for processing. The screener 1805 replies to the message, returning it to the sender with a request for verification that this message is not unsolicited advertisement or some other form of Spam. If the verification message 1801 receives no response within a predetermined time, the message is sent to the rejected message folder for disposal. If the verification message 1801 does receive a response, the message is routed as a passed message 1809.

The passed message 1809 is processed by the ranker 1813, which uses an internal ranker model 1814 to assign a priority value to the message. The ranker model determines the priority value based on the corpus of action records 1812 stored in the user action history 1811. Thus, the priority values assigned to each message are determined by the intentions of the recipient, as expressed in the user's responses to previous messages. As the user responds to messages, the system constantly adapts to the user's preferences.

The ranked message 1815 is next processed by the unread mail priority list 1816, which displays unread messages to the user in order of priority. As each message is presented for reading, the user is also provided with action cues 1822, offering likely alternatives for actions to be taken. These action cues 1822 are provided by the dispatcher 1819, which maintains an internal dispatcher model 1820. The dispatcher model 1820 is tuned by observing the contents of message folders 1823 in which previously read messages are organized. The contents of the current unread message 1817 is compared to the contents of messages in the message folders 1824 to offer an action cue such as “Move message to Work folder.” This enables the user to perform an action he is most likely to take (based on recorded past experience) by simply pressing the button created by the action cue.

The dispatcher 1819 responds to user actions on read messages 1818 to route these messages to the appropriate message folders 1824. Dispatched messages 1821 are stored in these folders until deleted by the user.

The final embodiment of the disclosed Communications Controller enables the consumer to effectively control the acceptance and presentation of incoming content from a television, such as broadcast programs, digital music, or movies-on-demand. It also permits the consumer to establish priorities for incoming content. These priorities are then used to automatically present content choices through the set-top box's display software to the consumer in a manner that suits the consumer's specific mood, needs, and values. If desired, unwanted incoming content choices (e.g., from adult-audience channels) will not even be shown to the recipient. Therefore, at the option of the receiving party, the receiving party's time is not wasted searching through hundreds of channels to find content of interest. The disclosed controller advantageously transforms the television content presentation system into a controllable device, which provides efficient and effective timely, value-added communication.

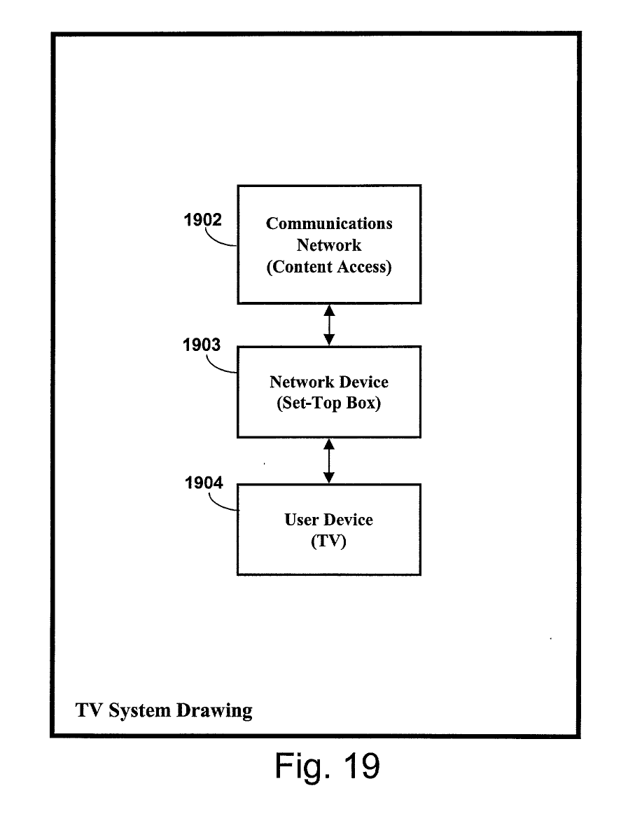

The controller manages and controls incoming content communications depending on the time-of-day, frequency, type, duration, user's mood, learned user behavior, and priority rating of the received communication. The functions of the present invention may be implemented in the television set-top box software or at any other point in the communications stream, but they are implemented in the television set-top box software for illustration purposes. FIG. 19 depicts the system drawing where the Communications Network 1901 supplies the content to the network device 1902 which is received by the user's device 1903. The term “set-top box” refers to a software and hardware device connected to a television service over a communication network. Applicant's communication controller 200 is implemented in such a set-top box using computer software and hardware.

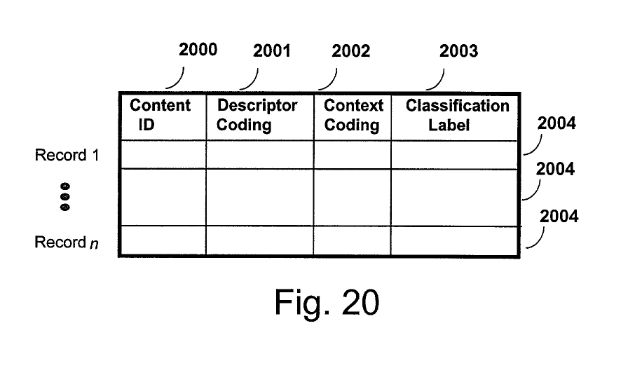

The User Action History database structure includes a plurality of records 2004 that are designated as Records 1 . . . n. As shown in FIG. 20, each record includes a content ID field 2000; a descriptor coding field 2001; a context coding field 2002; and a classification label field 2003.

The content ID 2000 is the unique identifier assigned to each incoming content item. The descriptor coding field 2001 is used to store a coding of the content description, such as type of media (movie, sports, music, etc.), actors, teams, or performers involved, and possibly a coding of words used in the description of the content. The context coding field 2002 is used to store coded contextual information such as the time of day and day of the week the content is offered. Upon the database memory becoming inadequate to store additional records 2004, a portion of the database is reduced in size by using data clustering methods. The classification label field 2003 contains an indicator for a specific action the user applied to this content.

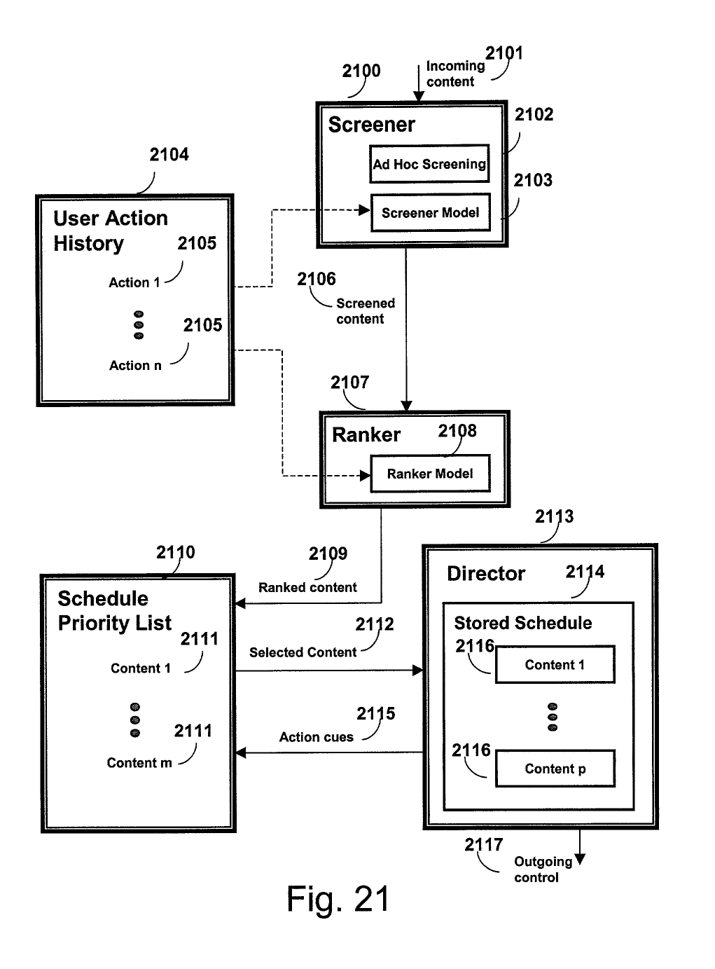

As depicted in FIG. 21, incoming content 2101 is first handled by the Screener 2100, which decides, based on ad hoc screening 2102 and a screener model 2103, whether the content should be passed as screened content 2106. The ad hoc screener 2102 uses heuristic methods based on foreknown expert knowledge to make a passed/rejected decision. For example, the user may have indicated in a survey that he is not interested in soccer, but is interested in football. The screener model 2103 is an adaptive component of the screener 2100, using the user action history 2104 to adapt its decisions to the user's preferences.

The user action history 2104 records data corresponding to specific actions taken by the user. For example, if the user views a movie and determines the movie to be objectionable, he may indicate this using the set-top box's user interface. This action would cause a new record 2105 to be created, containing the objectionable movie's ID 2000, a coding of the movie's description 2001, a coding of the movie's context 2002, and a classification label 2003 corresponding to the negative response of the user. Alternatively, if the user had responded positively to the message, a similar record 2112 would have been created, but with a classification label 2003 corresponding to a positive response. Over time, this record of user actions comprises a data source to be used for tuning the screener model 2103 and the ranker model 2107. This functions to adapt the operation of screening and ranking content to the demonstrated preferences of the user.

The screened content 2106 are processed by the ranker 2107, which use an internal ranker model 2108 to assign a priority value to the content. The ranker model determines the priority value based on the corpus of action records 2105 stored in the user action history 2104. Thus, the priority values assigned to each content item are determined by the intentions of the recipient, as expressed in the user's responses to previous content. As the user responds to content, the system constantly adapts to the user's preferences.

The ranked content 2109 are processed next by the schedule priority list 2110, which displays screened and ranked content to the user for selection. As each message is considered for selection, the user is also provided with action cues 2115, offering possible scheduling conflicts and likely alternatives for actions to be taken. These action cues 2115 are provided by the director 2113, which maintains a stored schedule 2114. The schedule details of the each content item 2111 are compared to the contents of the current stored schedule 2114 and other content listings 2111 to offer an action cue such as “Record this item for future viewing.” This enables the user to perform an action he is most likely to take (based on recorded past experience) by simply pressing the button created by the action cue.

The director 2113 responds to user actions on selected content 2112 to send the required outgoing control signals 2116 to other components of the set-top box.

Finally, implementations of the Communications Controller can utilize Intelligent Agents in order to provide the capability to selectively choose which device of a multiple of devices receives the incoming communication based on core Communications Control functions and based on the user's mood or the mode of operation of the device being controlled. The Communications Controller Engine comprises of one or more “intelligent software agents.” Multiple agents, acting in concert, perform specific tasks for which each agent has specific capabilities and goals. As such, the Communications Controller Agent(s) performs the following functions:

1) Performs actions on behalf of the user, such as allocating resources, making decisions, and performing tasks,

2) Utilizes specialized communication and analysis proficiencies,

3) Adapts to a changing environment; and

4) Utilizes artificial intelligence to accomplish these tasks.

Enabling it to move to the most advantageous processor further enhances the Communications Controller for the intelligent software agent, making it a “mobile software agent.” The software is capable of relocating itself to other Communications Controller-enabled communication devices within the communication chain. The Communications Controller Agent system is able to move to whatever device the user is utilizing or to run at more central locations in the communication pipeline. For example, Communications Controller software agents for telephony applications may execute on personal telephones, gateways, or at the phone company's Central Office.

The Communications Controller intelligent software agent performs the task of interfacing with human beings through voice prompts and voice recognition, visual interfaces, processing of key presses and other means. This capability classifies at least one of the Communications Controller Agents as a “social agent.” The Communications Controller Interface Agent communicates with the users of the Communications Controller-enabled device and adapts the interface to accommodate the users' behaviors.

An important overall goal of the Communications Controller Agent system is to enhance the security and privacy of the user's communications. The Security-Privacy Agent achieves the goals of learning user preferences regarding what incoming communication should be allowed and enforcing those preferences. The Security-Privacy Agent works in cooperation with the Interface Agent, which provides communication between the user and the Security-Privacy Agent.

While a method for controlling incoming communications has been described above, it is clear a communications system for processing incoming communications which include caller identification information is also disclosed. In summary, the disclosed system includes a caller identification device for receiving the incoming communication and extracting caller identification information from the incoming communication. The system also includes a user communications device for receiving and providing an incoming communication to a user of the communications device. The system further includes a communications controller coupled between the caller identification device and the user communications device. In one embodiment, the controller includes a processor for executing code to control the transmission of incoming communications to the user communications device. The controller further includes a memory for storing code for execution by the processor to control the transmission of incoming communications to the communications device. The stored code includes a caller database having a plurality of records, each record including caller identification information corresponding to a particular caller and a respective priority selected from a plurality of priorities. The stored code also includes a blocking time database having a plurality of records respectively corresponding to the plurality of priorities and including respective blocking time information for each priority. As discussed earlier in detail, depending on the time that a particular incoming communication is received and which of the plurality of priorities it is accorded, the communication is blocked, permitted or other appropriate action is taken.

In summary, the disclosed method and apparatus advantageously limits a communications device user's exposure to undesired communications by employing advanced control mechanisms implemented at or near the communications device in these embodiments. The control methodology and apparatus permits the consumer to proactively take control of how, when, and if the customer responds to incoming communications. Advantageously, the disclosed methodology transforms the communications device/solution (e.g., telephone, computer, wireless device, PDA, Internet Appliance, consumer equipment, Residential Gateway, television set-top box, and/or television) from a passive device to a controllable device that incorporates individual time management values and customized consumer priorities. Incoming communications are managed and controlled depending on the time-of-day, frequency, type, and priority rating of the particular communications being received. In this manner, the user is empowered to take control over incoming communications. Behavior modeling is performed to personalize the experience for the user without the need for programming. The mood of the user is sensed so dynamic control can be implied.

While only certain preferred features of the invention have been shown by way of illustration, many modifications and changes will occur to those skilled in the art. It is, therefore, to be understood that the present claims are intended to cover all such modifications and changes, which fall within the true spirit of the invention.

What is claimed is:

1. A method for processing an incoming communication from a calling party sent to a communications device 1014 of a receiving party, the method comprising the steps of:
storing a caller database including a plurality of records, each record including caller identification information corresponding to a particular caller and a respective priority selected from a plurality of priorities; and
storing a blocking time database including a plurality of records respectively corresponding to the plurality of priorities and including respective blocking time information for each priority.

2. The method of claim 1 further comprising the steps of:
receiving an incoming communication including caller identification information;
reading call time data to determine the time that the incoming communication is received to provide a call received time.

3. The method of claim 2 further comprising the steps of:
searching the caller database to find a record having caller identification information matching the caller identification information of the incoming communication and retrieving the respective priority for that record to produce a retrieved priority;
searching the blocking time database to determine blocking time information associated with the retrieved priority to produce retrieved blocking time information.

4. The method of claim 3 further comprising the steps of:
comparing the call received time of the incoming communication with the retrieved blocking time information;
blocking the incoming communication if the call received time occurs during a blockout time indicated by the retrieved blocking time information and otherwise permitting the incoming communication to be routed to the user of the communications device.

5. The method of claim 1 further comprising the step of selecting, by the user, the respective priority stored in the caller database for particular callers whose identification information is stored therein.

6. The method of claim 1 further comprising the step of selecting, by the user, the respective blocking time information for the priorities stored in the blocking time database.

7. The method of claim 1 wherein the identification information depends on the identity of the communication device of the calling party.

8. The method of claim 1 wherein the identification information depends on the telephone number of the calling party.

9. The method of claim 1 wherein the identification information depends on the IP address of the calling party.

10. The method of claim 1 wherein the identification information depends on the identity of the calling party.

11. The method of claim 1 further comprising the steps of:
storing a silence mode relative blocking time in the communications device; and
blocking incoming communications for the communications device temporarily while the silence mode relative blocking time is in effect.

12. The method of claim 1 in which the storing a caller database step further includes storing a frequency field in a record of the caller database to set a limit to the number of times an incoming communication is permitted during a selected time period from the particular calling party associated with that record.

13. The method of claim 1 in which the storing a caller database step further includes storing a duration field in a record of the caller database to set a limit to the amount of time an incoming communication is permitted. Upon this time limit being exceeded, an indication such as a beep will be invoked.

14. The method of claim 1 further comprising the step of:
storing an outgoing message (OGM) mapped to the caller identification information in a record of the caller database for a particular calling party;
receiving an incoming communication from the particular calling party; and
playing the outgoing message to the particular calling party when the calling party's identification information is detected by the communications device.

15. A communications system for processing incoming communications which include caller identification information, the system comprising:
a caller identification device 1003 for receiving the incoming communication and extracting caller identification information from the incoming communication;
a user communications device 1014 for receiving and providing an incoming communication to a user of the communications device;
a communications controller 1013 coupled between the caller identification device and the user communications device, the controller including:
a processor 1006 for executing code to control the transmission of incoming communications to the user communications device;
a memory 1007, 1008 for storing code for execution by the processor to control the transmission of incoming communications to the communications device, the code including a caller database including a plurality of records, each record including caller identification information corresponding to a particular caller and a respective priority selected from a plurality of priorities, the code further including a blocking time database having a plurality of records respectively corresponding to the plurality of priorities and including respective blocking time information for each priority.

16. The communications system of claim 15 wherein the code includes a caller database search routine which when executed by the processor searches the caller database in RAM memory 1007 to find a record having caller identification information matching the caller identification information of an incoming communication and retrieves the respective priority for that record to produce a retrieved priority.

17. The communications system of claim 16 wherein the code further includes a blocking time database search routine which when executed by the processor determines blocking time information associated with the retrieved priority to produce retrieved blocking time information.

18. The communications system of claim 17 wherein the code further includes a compare routine for comparing the time of the incoming communication with the retrieved blocking time information.

19. The communications system of claim 18 wherein the code further includes a blocking routine for blocking the incoming communication if the time of the incoming communication occurs at a blocking time indicated by the retrieved blocking time information and otherwise permitting the incoming communication to be routed to the user communications device.

20. The communications system of claim 15 further comprising priority selecting means for selecting, by the user, the respective priority for particular callers whose identification information is in the caller database.

21. The communications system of claim 15 further comprising blocking time selecting means for selecting, by the user, the respective blocking time information for the priorities stored in the blocking time database.

22. The communications system of claim 15 wherein the identification information depends on an IP address of the calling party.

23. The communications system of claim 15 wherein the identification information depends on the identity of the calling party.

24. The communications system of claim 15 further comprising:
storing means 1011 for storing a silence mode relative blocking time in the communications controller; and
blocking means 1009 for blocking incoming communications for the user communications device temporarily while the silence mode relative blocking time is in effect.

25. The communications system of claim 15 wherein a record of the caller database includes a frequency field which sets a limit for the number of times an incoming communication is permitted during a selected time period from the particular caller associated with that record.

26. The communications system of claim 15 wherein the caller database includes a record having an outgoing message (OGM) mapped to the caller identification information stored therein for a particular caller, the outgoing message (OGM) to be played to the particular caller when the particular caller's identification information is detected by the communications device.

27. A method for processing incoming communication sent to a communications device of a receiving party, the method comprising the steps of:
storing at least one of a plurality of originating source criteria;
storing at least one of a plurality of time criteria; and
storing at least one of a plurality of associated relative classification criteria, for classifying an incoming communication as a function of at least one of source and time.

28. The method of claim 27 further comprising the steps of:
said receiving party communications device possesses at least one of a plurality of device states where the said device state determines current associative device functions.

29. The method of claim 28 further comprising of:
said device state can be designated as mode of operation.

30. The method of claim 27 further comprising the steps of:
receiving incoming communication including originating source criteria; and
reading current time criteria to determine the time data that the incoming communication is received to provide received time information.

31. The method of claim 30 further comprising the steps of:
searching the stored originating source criteria to find a match of the incoming communication originating source criteria;
retrieving associated relative classification criteria for the said match to provide a relative classification;
searching the associated time criteria of the incoming communication associated with the said retrieved relative classification to determine the time management functions to be used for the present incoming communication;
reading the present device state; and
processing relative classification criteria and the associated time management functions to provide the functional operation to be performed by the communications device of the receiving party for the present device state.

32. The method of claim 27 in which the storing of originating source criteria further includes storing associated frequency criteria to set a limit to the number of times an incoming communication is permitted during a selected time period from the associated originating source.

33. The method of claim 27 in which the storing of originating source criteria further includes storing associated duration criteria to set a limit to the amount of time an incoming communication is permitted and providing an indication when the set limit is exceeded.

34. The method of claim 27 in which the storing of originating source criteria further includes storing an associated outgoing message (OGM).

35. The method of claim 34 and including receiving incoming communication from a particular originating source; and playing the OGM to the particular originating source when the originating source is matched.

36. The method of claim 27 in which the storing of originating source criteria further includes storing an associated announcement or pre-selected user notification such as a ring pattern.

37. The method of claim 27 further comprising of receiving incoming communication from a particular originating source; and playing the announcement or a notification to the user when the originating source is matched by the receiving party's communications device and the time criteria are satisfied.

38. The method of claim 27 in which an emergency operation is executed upon a determination of an emergency condition by the receiving party's communication device per the receiving party's pre-selected device operation.

39. The method of claim 38 further comprising of:
receiving and storing incoming communication emergency indication;
reading the emergency indication;
retrieving receiving party's communication device operation to be executed upon an emergency condition indication; and
invoking the designated device operation to be executed upon an emergency condition indication.

40. The method of claim 39 further comprising of:
receiving and decoding DTMF inputs from incoming communication source to indicate an emergency condition.

41. A method for the user rating a communication comprising of the following steps of:
establishing a communication link type;
establishing the communication source identification;
the user receiving the communication;
the user providing feedback criteria on how much they liked the communication; and
storing the user provided feedback criteria for future use.

42. The method of claim 41 wherein the communication link type is selected from the group comprising:
a voice type;
an internet content type;
a video type;
a multimedia type;
a fax type; and
a broadcast media type.

43. The method of claim 41 where the communication source identification is selected from the group comprising:
a voice communication identity;
an internet protocol identity;
a video source identifier;
a multimedia identifier;
a fax identifier; and
a broadcast media identifier.

44. The method of claim 43 where the communication source identification for a voice communication identity is selected from the group comprising:
a caller identity; or
a calling device identity.

45. The method of claim 41 where the feedback criteria is a relative priority rating.
